(19) United States
(12) Patent Application Publication
(10) Pub. No.: US 2003/0185007 A1
(43) Pub. Date: Oct. 2, 2003

(54) Colorful pattern lighting structure

(76) Inventor: Pui-Hing Tsui, Kowloon (HK)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/365,349

(22) Filed: Feb. 12, 2003

(30) Foreign Application Priority Data
Apr. 2, 2002 (CN) 02226567.8

(51) Int. Cl. F21V 9/00; F21V 21/00

(52) U.S. Cl. 362/249; 362/231

(57) ABSTRACT

A colorful pattern lighting structure comprises a core wire, a light string which is formed by a plurality of miniature bulbs sequentially connecting each other, multi-sectional thermal shrink membranes of different colors being sequentially disposed along the outside of the core wire, and a housing provided on the thermal shrink membranes. The present invention employs a structure of providing color thermal shrink membranes onto a core wire in order to conveniently form a colorful lighting string in accordance with the desired pattern. It successfully overcomes the problem existing in the conventional colorful lighting which needs to trim the wires and rearrange the connecting devices, thereby saving costs, reducing manufacturing procedures, ensuring waterproof, achieving high reliability. In addition, the present invention can ensure a uniform color on the lighting. The gap between two colors is considerably small in order to obtain a lighting string having high-density and changeable color combination. The present invention provides a simple lighting structure which is easily manufactured.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention is directed to an ornamental lighting, particularly to a colorful pattern lighting.

2. Description of the Related Art

The conventional colorful pattern lighting is produced by cutting off a variety of single-color string lights and then using connecting devices to assemble them into the desired colorful pattern. Such a structure cannot be customized and should need a lot of connecting devices for assembling, which will result in severe problems in relation to water proof and electricity safety. In particular, according to this technology, it is impossible to form a lighting having a short-sectional colorful pattern and therefore the usage and illumination effects are considerably restricted.

Given the above, an improved colorful lighting is developed. A transparent layer encloses a core wire and bead bulbs, which are coated or sprayed with color paint or ink. This technology is to form colorful pattern in the interior of the lighting first and then enclose a transparent layer outside, thereby obtaining colorful lighting. Nevertheless, this lighting still faces the following problems:

(a) Because the bead bulbs and the PVC material have different adhesion properties with respect to the paint applied thereto, the painting procedure will be rather difficult and the painting will also be uneven, which will tend to be a phenomenon of light leakage and significantly affect the visual appearance.

(b) The ink or paint applied thereto does not tend to be dried easily. This will be inconvenient during mass production. Furthermore, during assembling the lighting, the peeling of painted surface will cause the light leakage.

(c) It is very difficult for the manufacturer to produce a lighting having extremely short color intervals. Therefore it is impossible to produce a high-density colorful lighting strip. This will affect the whole color arrangement of the pattern lighting as desired by the designer.

(d) During assembly of the lighting, the paint will produce funky smell which may harm the labor's health and pollute the air in the working place.

### BRIEF SUMMARY OF THE INVENTION

The objective of the present invention is to provide a colorful pattern lighting structure which is convenient to be produced and has uniform color distribution therein. Such lighting will not lose color, has no light leakage, is easy to produce and has high production efficiency.

The present invention relates to a colorful pattern lighting that comprises a core wire, a light string which is formed by a plurality of miniature bulbs sequentially connecting each other, characterized in that multi-sectional thermal shrink membranes of different colors are sequentially disposed along the outside of a core wire, and a housing is provided on the thermal shrink membrane.

The present invention employs the structure of a core wire enclosed by color thermal shrink membranes in order to obtain a colorful light string having a variety of color arrangement according to the desired pattern. Therefore the need of trimming wires and offering connecting devices as existing in the conventional technology can be well overcome, thereby saving usage of resources, simplifying manufacturing process, reducing labor costs, even ensuring water proof, and enhancing product reliability. The present invention further efficiently avoids the difficulty in painting on the wire, the problem of losing paint from the painted surface, the tendency of light leakage, and the diffusion of funky smell from the paint. According to the present invention, the color shown on the lighting is quite uniform and the intervals between different colors can be extremely tiny, thereby easily obtaining a lighting having high color density. The present invention utilizes simple construction and easy manufacturing process to make a utility product.

### BRIEF DESCRIPTION OF THE SEVERAL VIEWS OF THE DRAWINGS

FIG. 1 is a schematic view showing the claimed lighting structure.

### DETAILED DESCRIPTION OF THE INVENTION

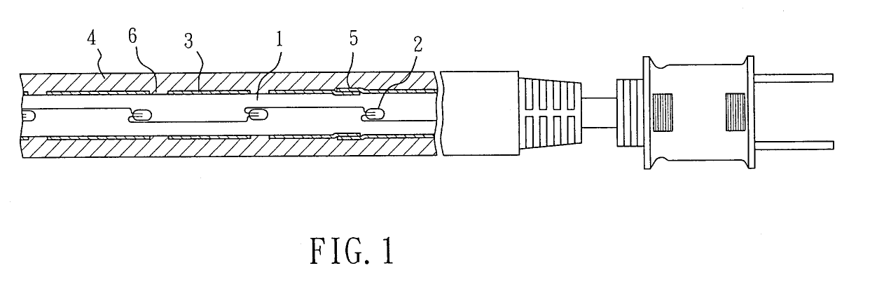

As shown in FIG. 1, the lighting includes a core wire (1), a light string (2) which is formed by a plurality of miniature bulbs sequentially connecting each other, wherein the miniature bulbs of the string (2) are arranged either in a horizontal way as shown in FIG. 1 or in a vertical way. Multi-sectional thermal shrink membranes 3 of different colors are sequentially disposed along the outside of core wire (1), and a housing (4) is provided on the thermal shrink membranes, wherein every two adjacent sections of the thermal shrink membranes (3) adjoin to each other. Alternatively, if necessary, any two of the adjacent thermal shrink membranes (3) are spaced apart from each other by a transparent blank section (6), and either or both of the ends of the light string (2) can also blank like the transparent section (6), thereby forming a pattern lighting which shows at least one section presenting white light produced by the corresponding miniature bulb itself. This can make the present invention conveniently form pattern lighting with a variety of colors and configuration.

The above descriptions are merely directed to preferred embodiments implementing the claimed invention. Any conceptual or structural modification to the invention as set forth in the following claims shall be considered falling with the scope sought to be patented.

1. A colorful pattern lighting structure, comprising:
a core wire (1),
a light string (2) which is formed by a plurality of miniature bulbs sequentially connecting each other,
multi-sectional thermal shrink membranes (3) of different colors being sequentially disposed along an outside of the core wire (1), and
a housing (4) provided on the thermal shrink membranes (3).

2. A colorful pattern lighting structure, wherein every two of the adjacent thermal shrink membranes (3) adjoin to each other.

3. A colorful pattern lighting structure, wherein any two of the adjacent thermal shrink membranes (3) are spaced apart from each other by a transparent blank section (6).
